(19) United States
(12) Patent Application Publication
(10) Pub. No.: US 2010/0154552 A1
(43) Pub. Date: Jun. 24, 2010

(54) CAPACITANCE DIAPHRAGM GAUGE AND VACCUM APPARATUS

(75) Inventor: Haruzo Miyashita, Yamanashi-ken (JP)

Correspondence Address: FITZPATRICK CELLA HARPER & SCINTO, 1290 Avenue of the Americas, NEW YORK, NY, 10104-3800, US

(73) Assignee: CANON ANELVA TECHNIX CORPORATION, Kawasaki-shi (JP)

(21) Appl. No.: 12/645,586

(22) Filed: Dec. 23, 2009

(30) Foreign Application Priority Data
Dec. 24, 2008 (JP) 2008-327966
Dec. 11, 2009 (JP) 2009-282207

(51) Int. Cl. G01L 9/12

(52) U.S. Cl. 73/718

(57) ABSTRACT

A capacitance diaphragm gauge includes an inclination angle sensor which detects the inclination angle of the gauge. The pressure dependences of capacitance obtained when the capacitance diaphragm gauge is mounted on a vacuum apparatus at the first inclination angle (+90°), the second inclination angle (0°), and the third inclination angle (−90°) are stored in a storage unit in advance. A pressure measurement value is then corrected based on the inclination angle information detected by the inclination angle sensor and the capacitance-pressure characteristic data is actually measured at the first, second and third inclination angles, and stored in the gauge.

### BACKGROUND OF THE INVENTION

1. Field of the Invention

The present invention relates to a capacitance diaphragm gauge used for pressure measurement and a vacuum apparatus, more particularly, to a capacitance diaphragm gauge suitable for pressure measurement in a vacuum apparatus such as a sputtering apparatus or an etching apparatus.

2. Description of the Related Art

FIG. 5 is a view schematically showing the capacitance diaphragm gauge disclosed in the specification of U.S. Pat. No. 4,785,669. Referring to FIG. 5, reference numeral 100 denotes a capacitance diaphragm gauge to measure a pressure inside a vacuum apparatus 2; and 16, a case covering the capacitance diaphragm gauge 100. The case 16 incorporates a getter 13, an insulting member 6, a fixed electrode 5, a circuit board 9, and the like.

A conductive housing 15 incorporates a reference pressure chamber (vacuum sealed chamber) 1 which is sealed while its interior is kept at a high vacuum by the getter 13. The reference pressure chamber 1 is partitioned from an area 3 communicating with the vacuum apparatus 2 by a diaphragm. The fixed electrode 5 is disposed in the reference pressure chamber 1 so as to face the diaphragm. Although the diaphragm will be described below, since it also functions as an electrode, it will be referred to as a diaphragm electrode 4.

The fixed electrode 5 is formed on the rigid insulting member 6. An interconnection extends from the fixed electrode 5 to the opposite surface through a through-hole interconnection 7 formed in the insulting member 6. The fixed electrode 5 is connected to the circuit board 9 through this interconnection and a vacuum seal feed-trough 8.

The diaphragm electrode 4 is, for example, made of a conductive material or by forming a conductive film on an insulating material so as to have a structure to function as an electrode. The diaphragm electrode 4 is placed inside the conductive housing 15. The diaphragm electrode 4 is connected to the circuit board 9 through the conductive housing 15 and a conductive wire 17.

When there is a pressure difference between the reference pressure chamber 1 and the area 3 communicating with the vacuum apparatus 2, the diaphragm electrode 4 displaces toward the fixed electrode 5 side in accordance with the pressure difference. At this time, since the capacitance between the diaphragm electrode 4 and the fixed electrode 5 is inversely proportional to their distance, these pieces of electrical information are transmitted to units on a circuit board 9 via the through-hole interconnection 7, the vacuum seal feed-trough 8, the conductive wire 17, and the like. The capacitance detected by a capacitance detection unit 21 on the circuit board 9 is converted into a voltage value or a current value. A pressure correction unit 22 corrects the voltage value or the current value. An electric input/output terminal 10 outputs the corrected voltage value or the corrected current value to the outside of the gauge, thereby measuring a pressure.

Note that the case 16 has a shield function, which has a structure to cover the overall gauge including the conductive housing 15, the capacitance detection unit 21, the pressure correction unit 22, the circuit board 9 and so on so as to prevent the influence of external noise. The capacitance detection unit 21 and the pressure correction unit 22 are placed on the circuit board 9.

In the capacitance diaphragm gauge disclosed in the specification of U.S. Pat. No. 4,785,669, the diaphragm electrode 4 displaces due to a gas pressure existing in the area 3 communicating with the interior of the vacuum apparatus 2. The gauge measures the gas pressure by detecting the displacement as a capacitance change and then converting it into an electrical signal. When the capacitance diaphragm gauge 100 is to be calibrated, the displacement amount of the diaphragm electrode 4 is minimized by sufficiently decreasing the pressure in the area 3 communicating with the vacuum apparatus 2.

In this state, the signal value output from the electric input/output terminal 10 is adjusted to a zero pressure to be set to a reference point (which is generally referred to as zero point adjustment). This gauge is configured to detect the amount of displacement of the diaphragm electrode 4 from this state and outputs it as a voltage value from the electric input/output terminal 10. On the circuit board 9, a zero point adjustment potentiometer 11 is fixed for performing this adjustment.

In general, in the process of manufacturing a capacitance diaphragm gauge, assembly and adjustment are performed while a connection fitting 12 for connection to the vacuum apparatus 2 faces downward, as shown in FIG. 5. If the user installs the capacitance diaphragm gauge on the vacuum apparatus 2 such that the connection fitting 12 faces downward in the same manner, it is possible to measure a pressure without any problems.

In some cases, however, the user has no choice but to install the capacitance diaphragm gauge such that the connection fitting 12 of the gauge faces upward or laterally depending on conditions for the mount port of the vacuum apparatus 2 in an environment where the capacitance diaphragm gauge is used. In such a case, the user needs to assemble and adjust a capacitance diaphragm gauge in a special manner in accordance with the situation of installation.

In a capacitance diaphragm gauge with high sensitivity, capable of measuring pressures of 100 Pa or less, if the connection fitting 12 is mounted on the vacuum apparatus 2 so as to face a direction different from that when the gauge is assembled and adjusted, measurement pressure accuracy has an influence that cannot be neglected. Assume that the capacitance diaphragm gauge shown in FIG. 5 includes the diaphragm electrode 4 made of stainless steel and having a thickness of 50 μm and a diameter of 40 mm. Manufacturing a capacitance diaphragm gauge with dimensions set to have a distance of 20 μm between the diaphragm electrode 4 and the fixed electrode 5 can obtain a capacitance diaphragm gauge with a full scale pressure of 10 Pa.

FIG. 6 shows the result obtained by simulation calculation of the relationship between the pressure applied to the diaphragm electrode 4 of the capacitance diaphragm gauge and the capacitance between the diaphragm and the fixed electrode. The abscissa represents pressure (Pa); and the ordinate, capacitance (pF). As shown in FIG. 6, the capacitance diaphragm gauge having the above structure changes in capacitance from 2.92 pF to 5.2 pF with changes in pressure in the range of 10 Pa, and a capacitance change of about 2.28 pF can be obtained.

The simulation result shown in FIG. 6, however, gives no consideration to the weight of the diaphragm electrode 4 itself. That is, since the specific gravity of stainless steel is 8.4, the diaphragm electrode 4 made of stainless steel and having a thickness of 50 μm and a diameter of 40 mm has a weight of 0.71 mg. In this case, on the ground where the gravitational acceleration is 9.8 kg/m², a downward force of 6.9×10⁻³ N is always applied to the diaphragm electrode 4. This is equivalent to that a pressure of 5.5 Pa is applied to the diaphragm electrode 4 having a diameter of 40 mm (area: 1.26×10⁻³ m²) at maximum (equivalent to a diaphragm displacement amount of about 2.5 μm).

In consideration of the above fact, therefore, in the capacitance diaphragm gauge exemplified here, the solid line in FIG. 7 shows the relationship between the pressure and the capacitance between the diaphragm electrode and the fixed electrode when the connection fitting 12 of the gauge is in the downward direction.

In addition, the broken line in FIG. 7 shows the pressure dependence of capacitance when the connection fitting 12 of the gauge is in the upward direction. Furthermore, the dash-dotted line in FIG. 7 shows the pressure dependence of capacitance when the connection fitting 12 is in the lateral direction (horizontal direction). As is obvious from the relationship shown in FIG. 7, capacitance characteristics with respect to pressure considerably vary depending on mount configuration for the gauge.

As described above, a general capacitance diaphragm gauge is often assembled and adjusted on the assumption that the gauge is used with the connection fitting 12 facing downward. That is, according to the characteristic shown in FIG. 7 (the characteristic indicated by the solid line), when the pressure is zero, there is a capacitance of 2.36 pF between the diaphragm electrode 4 and the fixed electrode 5. As the pressure rises to 10 Pa, the capacitance becomes 3.65 Pa. Finally, a capacitance change of 1.29 pF can be obtained.

At the time of actual assembly/adjustment, as indicated by the solid line in FIG. 8, the circuit board 9 is adjusted such that when, for example, the capacitance is 2.36 pF at a zero pressure, the output voltage is 0 V, and that when the capacitance is 3.65 pF at 10 Pa, the output voltage is 10 V. In addition, the pressure correction unit 22 is adjusted to establish a proportional relationship between pressure and output voltage.

If, however, this gauge is installed in the lateral direction (horizontal direction) or in the reverse direction, the capacitances at a zero pressure and a pressure of 10 Pa considerably differ from those described above. At the same time, the linearity of the characteristic differs from that in the above case. The dash-dotted line and broken line in FIG. 8 respectively indicate the relationship between pressure and output voltage when this gauge is installed in the lateral direction (horizontal direction) and the relationship between pressure and output voltage when the gauge is installed in the reverse direction.

Even if the output voltage at the zero point can be corrected by the zero point adjustment potentiometer 11 of the gauge, the output voltage value and the linearity with respect to 10 Pa cannot be corrected. As a consequence, this gauge has a characteristic indicated by the dash-dotted line or broken line in FIG. 8. This cannot be neglected when accurate pressure measurement is required.

As described above, since a capacitance diaphragm gauge is generally assembled and adjusted while the connection fitting for a vacuum apparatus faces downward, errors occur when the gauge is used at other inclination angles. Such errors have larger influences on gauges with higher sensitivity designed to measure lower pressures.

For this reason, when a capacitance diaphragm gauge cannot be mounted on a vacuum apparatus with the connection fitting facing downward due to various situations, the gauge needs to be adjusted in a special manner. This inevitably leads to an increase in the cost of the gauge itself.

### SUMMARY OF THE INVENTION

It is an object of the present invention to provide a capacitance diaphragm gauge which can perform accurate pressure measurement regardless of mount conditions for the gauge.

According to one aspect of the present invention, there is provided a capacitance diaphragm gauge comprising: a vacuum sealed chamber including a diaphragm electrode; a fixed electrode provided inside the vacuum sealed chamber so as to face the diaphragm electrode; and an inclination angle sensor configured to detect an inclination angle of the capacitance diaphragm gauge.

According to another aspect of the present invention, there is provided a vacuum apparatus comprising the above-described capacitance diaphragm gauge.

According to the present invention, the gauge can accurately measure a pressure regardless of the inclination angle of the gauge by correcting a pressure measurement value in accordance with the inclination angle of the gauge. Even if, therefore, the gauge cannot be mounted with the connection fitting facing downward due to various situations, there is no need to adjust the gauge in a special manner. This makes it possible to provide a capacitance diaphragm gauge at a low cost.

Further features of the present invention will become apparent from the following description of exemplary embodiments with reference to the attached drawings.

### BRIEF DESCRIPTION OF THE DRAWINGS

FIG. 1 is a schematic sectional view showing an embodiment of a capacitance diaphragm gauge according the present invention;

FIG. 2 is a view showing the range of the detection inclination angles of an inclination angle sensor used in the present invention;

FIG. 3 is a schematic sectional view showing a state in which the gauge of the present invention is mounted on a vacuum apparatus at an inclination angle of 45°;

FIG. 4 is a graph for explaining a method of correcting a pressure measurement value in the present invention;

FIG. 5 is a schematic sectional view showing a conventional capacitance diaphragm gauge;

FIG. 6 is a graph showing the result obtained by simulation calculation of the pressure dependence of capacitance between a diaphragm and a fixed electrode with respect to the pressure applied to a diaphragm electrode;

FIG. 7 is a graph showing differences in the pressure dependence of capacitance due to differences in the inclination angle of the gauge;

FIG. 8 is a graph showing differences in the pressure dependence of output voltage due to differences in the inclination angle of the gauge; and

FIG. 9 is an electric block diagram of the embodiment of the present invention.

### DESCRIPTION OF THE EMBODIMENTS

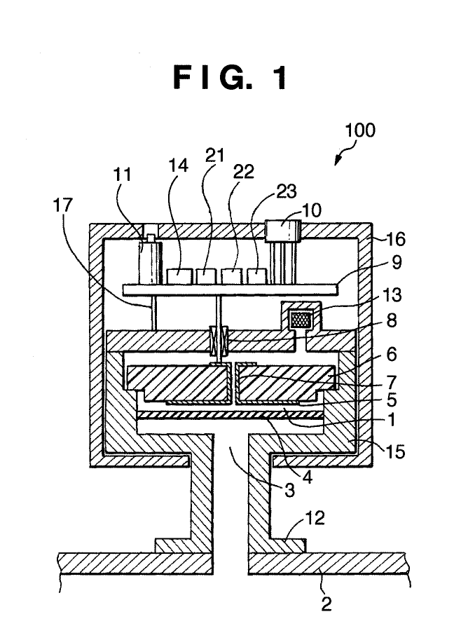

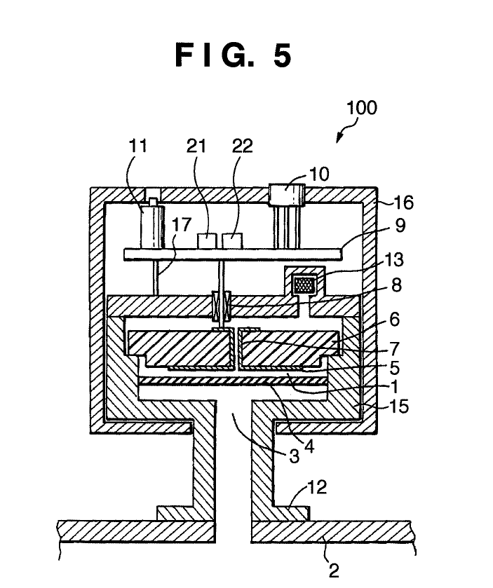

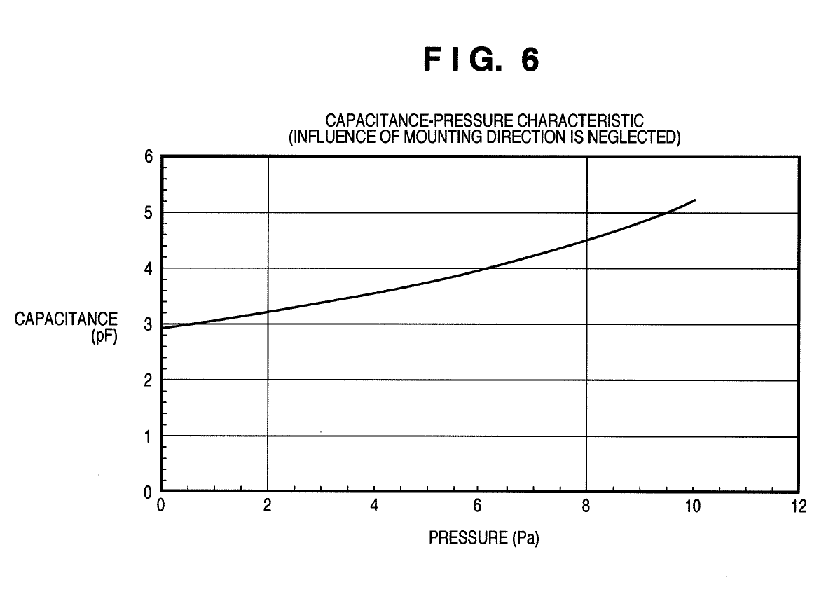

The best mode for carrying out the present invention will be described in detail below with reference to the accompanying drawings. FIG. 1 is a schematic sectional view showing an embodiment of a capacitance diaphragm gauge according to the present invention. The same reference numerals as in FIG. 1 denote the same parts in FIG. 5.

On the circuit board 9 shown in FIG. 1, the zero point adjustment potentiometer 11, an inclination angle sensor 14, the capacitance detection unit 21, a pressure correction unit 22, and a storage unit 23 are fixed. FIG. 1 differs from FIG. 5 in that the capacitance diaphragm gauge includes the inclination angle sensor 14, and the storage unit 23. The pressure correction unit 22 and the storage unit 23 correct a pressure measurement value based on the inclination angle of a capacitance diaphragm gauge 100 which is detected by the inclination angle sensor 14, as will be described later. A method of correcting a pressure measurement value by using the inclination angle sensor 14 and the like will be described in detail later.

A vacuum apparatus 2 includes, for example, a sputtering apparatus, an etching apparatus, and a CVD apparatus. The capacitance diaphragm gauge according to the present invention is used to measure a pressure inside the vacuum apparatus 2 as a measurement target. A capacitance diaphragm gauge is used in particular as a vacuum gauge capable of measuring a pressure with high accuracy and repeatability regardless of the type of gas. The principle and structure of this capacitance diaphragm gauge for measuring the pressure in an area 3 communicating with the interior of the vacuum apparatus 2 are the same as those of the conventional capacitance diaphragm gauge.

The conductive housing 15 incorporates a getter 13, an insulting member 6, and a fixed electrode 5. The conductive housing 15 also incorporates a reference pressure chamber 1 which is sealed while its interior is always kept at a high vacuum by the getter 13. The insulting member 6 is shaped such that a columnar member having a slightly smaller diameter than an outer diameter of a columnar base portion of the conductive housing 15 is stacked on the base portion. The insulting member 6 is shaped in this manner for the purpose of positioning relative to a conductive housing 15. The reference pressure chamber 1 is partitioned from the area 3 communicating with the vacuum apparatus 2 by a diaphragm electrode 4. The fixed electrode 5 is disposed in the reference pressure chamber 1 so as to face the diaphragm electrode 4.

The fixed electrode 5 is placed on the insulting member 6. An interconnection extends from the fixed electrode 5 to the opposite surface through a through-hole interconnection 7 formed in the insulting member 6. The fixed electrode 5 is connected to the circuit board 9 through this interconnection and a vacuum seal feed-trough 8.

The diaphragm electrode 4 is made of a conductive material or by forming a conductive film on an insulating material so as to have a structure to function as an electrode. The diaphragm electrode 4 is placed between the insulting member 6 and the conductive housing 15. The diaphragm electrode 4 is connected to the circuit board 9 through the conductive housing 15 and a conductive wire 17.

When there is a pressure difference between the reference pressure chamber 1 and the area 3 communicating with the vacuum apparatus 2, the diaphragm electrode 4 displaces toward the fixed electrode 5 side in accordance with the pressure difference. The capacitance between the diaphragm electrode 4 and the fixed electrode 5 is inversely proportional to their distance. For this reason, these pieces of electrical information are transmitted to the circuit board 9 via the through-hole interconnection 7, the vacuum seal feed-trough 8, the conductive wire 17, and the like. The capacitance detection unit 21 on the circuit board 9 converts the capacitance into a digital data and a voltage value or current value proportional to the pressure is obtained through the pressure correction unit 22 and the digital voltage converter 906. An electric input/output terminal 10 outputs the voltage value or the current value to outside the gauge, thereby measuring a pressure.

A means for detecting the above capacitance will be referred to as a capacitance detection unit, and is denoted by reference numeral 21. As will be described later, the capacitance detection unit 21 (FIG. 9) functions as both the capacitance detection unit 21 and a digital converter unit in this embodiment. Obviously, they can be separate units.

This embodiment also includes the inclination angle sensor 14 for detecting at which inclination angle the capacitance diaphragm gauge 100 is mounted. The inclination angle sensor 14 is mounted on the circuit board 9. A zero point adjustment potentiometer 11 is also mounted on the same circuit board 9. The inclination angle information of the capacitance diaphragm gauge 100 which is detected by the inclination angle sensor 14 is output to the pressure correction unit 22 (FIG. 9) on the circuit board 9. The pressure correction unit 22 corrects the output measurement value which is output from the electric input/output terminal 10 in accordance with the inclination angle, as will be described later.

FIG. 9 is a block diagram of a control circuit to control the operation of the capacitance diaphragm gauge 100 according to the embodiment of the present invention. The pressure applied to the diaphragm is corrected into the capacitance between the diaphragm and the fixed electrode. The capacitance detection unit 21 detects the capacitance by converting the capacitance into a digital value, and stores it in the storage unit 23 together with the measured pressure. On the other hand, although the inclination angle sensor 14 sends the inclination angle information of the gauge to the pressure correction unit 22 on circuit board 9, the pressure correction unit 22 on circuit board 9 corrects the above pressure-capacitance data in consideration of the inclination angle information and sends an appropriate digital pressure value to a digital/voltage converter 906. As a result, an electric input/output terminal 10 outputs a voltage corresponding to the pressure. The inclination angle sensor 14, the pressure correction unit 22, and the storage unit 23 function as the pressure correction means.

That is, the pressure correction unit 22 of the circuit board 9 corrects the pressure measurement value based on the inclination angle information from the inclination angle sensor 14 and the data stored in the storage unit 23 in advance.

As the inclination angle sensor 14, for example, a piezo-resistive 3-axis acceleration sensor is used. As this 3-axis acceleration sensor, piezo-resistive 3-axis acceleration sensor HAAM-312B available from HOKURIKU ELECTRIC INDUSTRY or the like can be suitably used. Using this 3-axis acceleration sensor eliminates the necessity to change the size of the gauge because the sensor is compact.

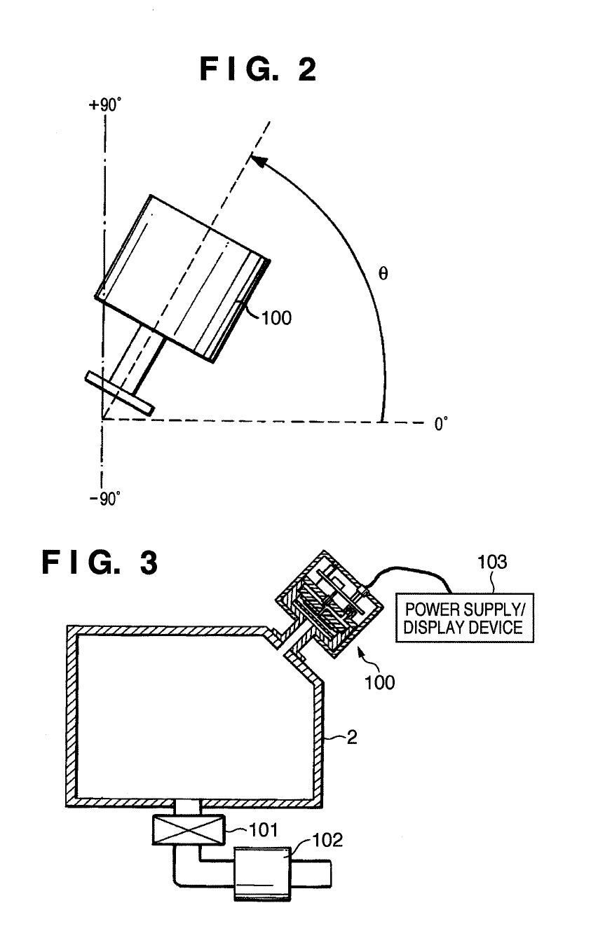

If an inclination angle θ is defined as shown in FIG. 2, it is possible to detect inclination angles in the range from −90° to +90°. In this embodiment, if, for example, the inclination angle in the horizontal direction is zero (θ=0) as shown in FIG. 2, +90° which differs by 90° from the horizontal direction is defined as the second inclination angle (θ=+90°) (the second inclination angle is the vertically upward direction). In addition, θ=0 which differs by 90° from the second inclination angle is defined as the first inclination angle. Furthermore, −90° which differs by −90° from the horizontal direction is defined as the third inclination angle (θ=−90°) (the third inclination angle is the vertically downward direction).

Throughout this specification, an inclination angle means the inclination angle of the capacitance diaphragm gauge 100 in use relative to its inclination angle when a straight line extending through the center of the diaphragm electrode 4 in a flat state, that is, a state in which it is neither concave nor convex, toward the reference pressure chamber 1 perpendicular to the diaphragm electrode 4 is horizontal (θ=0 in FIG. 2). It is possible to obtain this inclination angle directly or indirectly from an output signal from the inclination angle sensor 14.

As a means for converting a capacitance into a voltage in the circuit board 9, for example, digital converter AD7745 available from Analog Devices can be suitably used. The digital converter or the capacitance detection unit 21 has a function of converting the capacitance of a connected pressure sensor element (pressure/capacitance converter) into a digital numerical value. And the pressure correction unit 22 can convert the digital data by adjusting the span and the linearity of the sensor element's characteristics.

FIG. 3 shows an example of the vacuum apparatus 2 including the capacitance diaphragm gauge 100. That is, FIG. 3 shows an example of a state in which the capacitance diaphragm gauge 100 is mounted on the vacuum apparatus 2. FIG. 3 is a schematic sectional view showing a state in which the capacitance diaphragm gauge 100 is mounted at an angle of 45° (relative to 0° in FIG. 2). In general, the capacitance diaphragm gauge 100 is often mounted at an angle of +90° (with a connection fitting 12 facing downward). As described above, this embodiment can accurately measure the pressure inside the vacuum apparatus 2 by correcting a pressure measurement value regardless of the angle at which the capacitance diaphragm gauge 100 is mounted. Referring to FIG. 3, reference numeral 101 denotes a valve; 102, a vacuum pump; and 103, a power supply/display device.

A method of correcting a pressure measurement value based on inclination angle information in this embodiment will be described next. First of all, capacitance-pressure characteristic data must be stored in the storage unit 23. In this case, the characteristic data is obtained by actually measuring the capacitance between the fixed electrode 5 and the diaphragm electrode 4 of the gauge with changing the pressure in the area 3 communicating with the interior of the vacuum.

More specifically, a gauge for actually measuring a reference pressure and the capacitance diaphragm gauge 100 are mounted on the same vacuum apparatus, and the interior of the apparatus is evacuated. When a gas is then introduced into the vacuum apparatus to a predetermined pressure, the capacitance between the fixed electrode 5 and the diaphragm electrode 4 is measured. At this time, pressure measurement is executed by using the gauge for measuring a reference pressure. The capacitance-pressure characteristic data is obtained at a predetermined inclination angle by repeating this operation while changing the pressure, and stores in advance the data in the storage unit 23. The storage unit 23 forms a storage means.

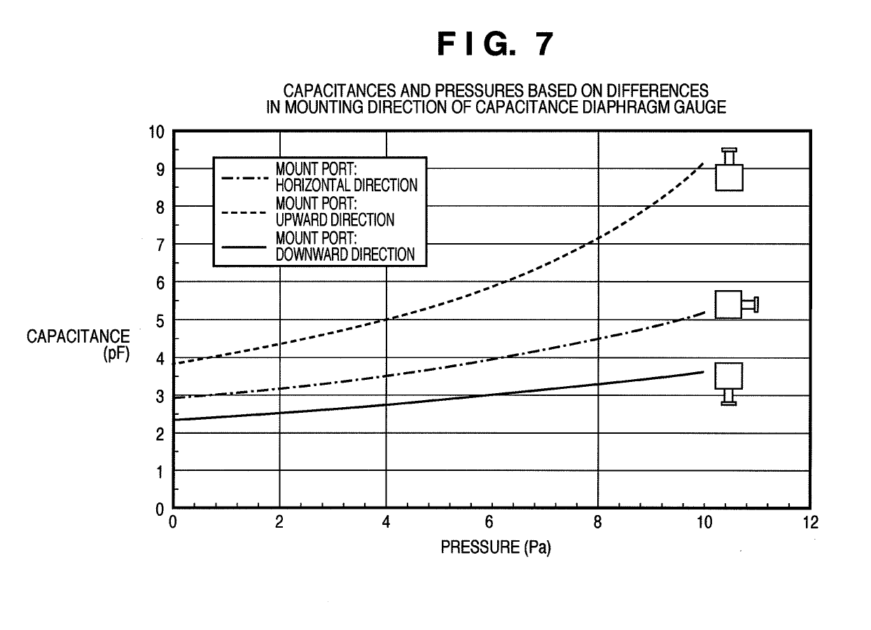

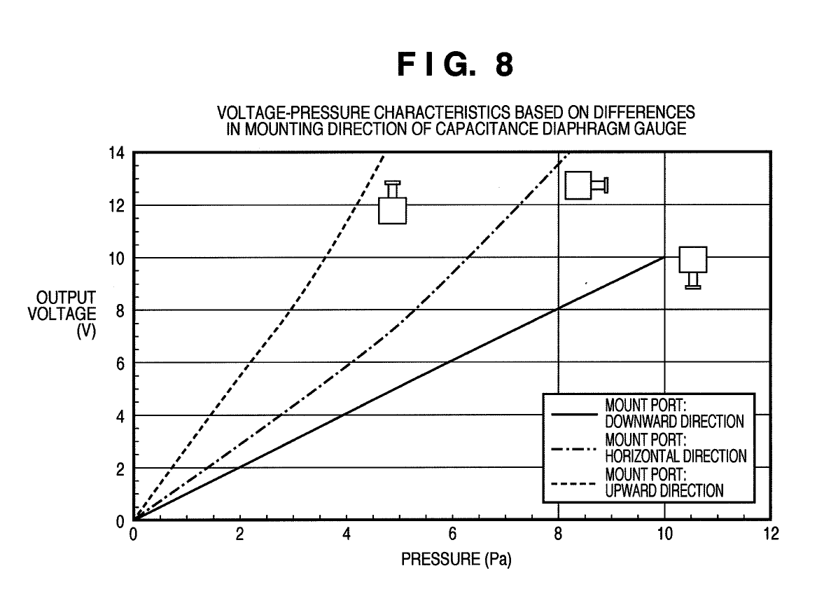

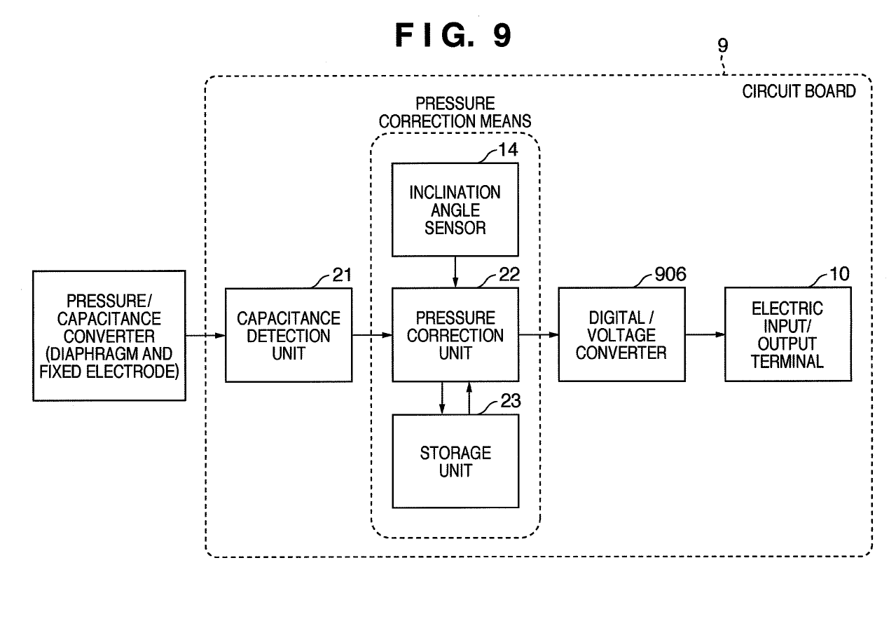

With this operation, a table of capacitance data relative to the reference pressure is generated in the storage unit 23. Therefore, when the pressure in the area 3 communicating with the interior of the vacuum apparatus changes, and the capacitance between the fixed electrode 5 and the diaphragm electrode 4 becomes a certain value, it is possible to calculate back to what pressure the capacitance corresponds. Then an output value (a voltage value or a current value) corresponding to the pressure is output from the electric input/output terminal 10 shown in FIG. 1. A storage means such as the storage unit 23 stores the capacitance-pressure characteristic data as the pressure dependence of capacitance with respect to a measurement inclination angle like that shown in FIG. 7.

In order to obtain the effects of the present invention in this case, the inclination angle sensor 14 detects inclination angle information indicating at what angle this gauge is inclined when executing the above operation for collecting data to be stored in the storage unit 23. The storage unit 23 stores the inclination angle information together with the capacitance-pressure characteristic data separately. It is also possible to prepare different storage means to store the inclination angle information and the capacitance-pressure characteristic data in advance.

More specifically, for example, the capacitance-pressure characteristic data in the respective states in which the connection fitting 12 of this gauge is in the vertically downward direction (θ=+90° in FIG. 2), in the horizontal direction (θ=0° in FIG. 2), and in the vertically upward direction (θ=−90° in FIG. 2) are measured and stored in the storage unit 23 together with the inclination angle information in advance.

According to the description above, the capacitance detection unit 21, the storage unit 23, and the pressure correction unit 22 are housed in the case 16 of the capacitance diaphragm gauge. However, they can be arranged outside the case 16. In this case, the electric input/output terminal 10 outputs a signal associated with the capacitance between the diaphragm electrode 4 and the fixed electrode 5 and inclination angle information, and an external unit including a capacitance detection unit, a storage circuit, and a pressure correction unit processes the data.

The state in which the connection fitting 12 is in the vertically downward direction is the state of this gauge shown in FIG. 1, that is, the state (the second inclination angle) in which the connection fitting 12 faces the vertically downward direction, and the state in which the connection fitting 12 is in the horizontal direction is the state (the first inclination angle) in which this gauge faces the horizontal direction. In addition, the state in which the connection fitting 12 is in the vertically upward direction is the state (the third inclination angle) in which the connection fitting 12 faces the upward direction (the gauge faces the direction opposite to that in FIG. 1).

Assume that the capacitance diaphragm gauge 100 is actually mounted on the vacuum apparatus 2 and a pressure is to be measured. In this case, when the capacitance diaphragm gauge 100 is installed at the angles represented by θ=+90°, 0°, and −90°, the inclination angle sensor 14 detects the inclination angle of the gauge. The inclination angle sensor 14 outputs inclination angle information to the pressure correction unit 22. Based on this inclination angle information, the pressure correction unit knows what specific capacitance-pressure characteristic data corresponding to a specific inclination angle stored in the storage unit 23 in advance it should refer to. The pressure correction unit 22 therefore refers to the capacitance-pressure characteristic data corresponding to the inclination angle information, and outputs an output value (a voltage value or a current value) corresponding to the pressure.

A correction method for a case in which the capacitance diaphragm gauge 100 is installed with the connection fitting 12 being set at an angle other than the vertically downward direction, horizontal direction, and vertically upward direction will be described next. When, for example, the capacitance diaphragm gauge 100 is installed with the connection fitting 12 being set at the angle represented by θ=45° as shown in FIG. 3, the inclination angle sensor 14 detects the inclination angle θ of the connection fitting 12, and outputs the detected angle to the pressure correction unit 22. In this case, the pressure correction unit 22 corrects the pressure measurement value by using the detected inclination angle θ in addition to the data in the above three states which are actually measured and stored in advance (the capacitance-pressure characteristic data with the inclination angles in the vertically downward direction, horizontal direction, and vertically upward direction).

More specifically, let A be a pressure corresponding to the detected capacitance based on pressure-capacitance data when the connection fitting 12 faces the vertically downward direction (θ=+90°; second inclination angle), B be a pressure corresponding to the detected capacitance based on pressure-capacitance data when the connection fitting 12 faces the horizontal direction (θ=0°; first inclination angle), and C be a pressure corresponding to the detected capacitance based on pressure-capacitance data when the connection fitting 12 faces the vertically upward direction (θ=−90′; third inclination angle). In this case, if the angle θ detected by the inclination angle sensor 14 satisfies 0°≦θ≦90° (first inclination angle≦θ≦second inclination angle), the pressure correction unit 22 performs computation according to

pressure=A×sin²θ+B×cos²θ (1)

to approximately correct the pressure measurement value.

If the angle θ detected by the inclination angle sensor 14 satisfies −90°≦θ<0° (third inclination angle≦θ<first inclination angle), the pressure correction unit 22 performs computation according to

pressure=B×cos²θ+C×sin²θ (2)

to approximately correct the pressure measurement value. Correcting a pressure measurement value by using a trigonometric function in this manner can accurately measure the pressure in the vacuum apparatus regardless of the inclination angle of the capacitance diaphragm gauge 100.

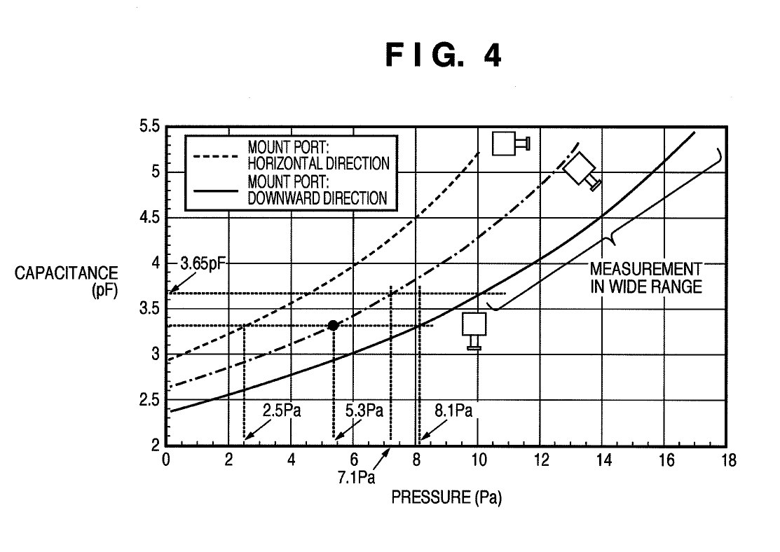

This correction method will be described in further detail next with reference to FIG. 4. FIG. 4 shows characteristics extracted in the cases in which the connection fitting 12 is in the horizontal direction (θ=0°) and in the vertically downward direction (θ=+90°) in FIG. 7. If, for example, the gauge is mounted with the connection fitting 12 being set at 45° in the downward direction (θ=45°) as shown in FIG. 3, the gauge exhibits the capacitance-pressure characteristic indicated by the dash-dotted line in FIG. 4. In this case, when, for example, the pressure in the area 3 communicating with the interior of the vacuum apparatus 2 is 5.3 Pa, the capacitance between the diaphragm electrode 4 and the fixed electrode 5 becomes 3.3 pF.

At this time, the storage unit 23 has stored only capacitance-pressure characteristic data in the cases in which the connection fitting 12 is in the vertically downward direction (θ=+90° indicated by the solid line in FIG. 4; the corresponding data will be sometimes referred to as data A hereinafter), in the horizontal direction (θ=0° indicated by the broken line in FIG. 4; the corresponding data will be sometimes referred to as data B hereinafter), and in the vertically upward direction (θ=−90° not shown in FIG. 4; the corresponding data will be sometimes referred to as data C hereinafter). For this reason, even if a capacitance of 3.3 pF is detected, an actual pressure of 5.3 Pa cannot be directly obtained. Therefore, a pressure of 5.3 Pa is calculated according to the following procedure.

First of all, the inclination angle sensor 14 detects that the inclination angle θ of the gauge is 45°, and outputs the detected angle to the pressure correction unit 22 on circuit board 9. The pressure correction unit 22 corrects the pressure measurement value by using the capacitance-pressure characteristic data in the cases in which the connection fitting 12 is in the downward direction (θ=+90°) and in the horizontal direction (θ=0°).

More specifically, the capacitance-pressure characteristic data in the case in which the connection fitting 12 is in the vertically downward direction (θ=+90° indicated by the solid line in FIG. 4) exhibits that 3.3 pF corresponds to a pressure of 8.1 Pa. The capacitance-pressure characteristic data in the case in which the connection fitting 12 is in the horizontal direction (θ=0° indicated by the broken line in FIG. 4) exhibits that 3.3 pF corresponds to a pressure of 2.5 Pa.

That is, in this case, substituting A=8.1 Pa and B=2.5 Pa into equation (1) will approximately correct the pressure measurement value by computation as follows:

pressure=8.1×sin²(45°)+2.5×cos²(45°)=5.3 Pa

If the pressure becomes 7.1 Pa or more when the inclination angle θ of the gauge is 45°, the capacitance becomes 3.65 pF. In this case, according to the capacitance to be referred to as A in equation (1), that is, the capacitance-pressure characteristic data in the case in which the connection fitting 12 is in the vertically downward direction (θ=+90° indicated by the solid line in FIG. 4), data corresponding to a pressure of 10 Pa or more is required.

Even if, for example, the full scale pressure of the gauge in this case is 10 Pa, data in a range wider than the operating pressure range of the gauge is required as capacitance-pressure characteristic data to be stored in the storage unit 23 to avoid the above inconvenience. That is, in this case, it is necessary to actually measure data in a pressure range wider than 10 Pa and store it inside the gauge, as shown in FIG. 4.

That is, in the above case, as shown in FIG. 4, as a characteristic in the case in which the connection fitting 12 is in the vertically downward direction, data can be measured up to a pressure of 18 Pa and stored in the storage unit 23 in advance. As a result, even if the capacitance becomes 3.65 pF or more, it is possible to measure an accurate pressure by performing correction in accordance with the inclination angle.

The above embodiment has been described on the assumption that the inclination angle θ of the gauge ranges from 0° to +90°. However, even in a case in which the gauge is installed with the connection fitting 12 facing upward from the horizontal direction as when the inclination angle θ is −90° to 0°, it is possible to correct the pressure measurement value by the same technique as described above. Note however that in this case, as capacitance-pressure characteristic data to be stored in the gauge in advance by using equation (2), correction is performed by using data B and data C respectively obtained when the connection fitting 12 is in the horizontal direction and in the vertically upward direction.

As is obvious from the above description, when the inclination angle is limited to 0°≦θ≦90° or −90°≦θ<0°, there is no need to store the pressure dependences of capacitance with respect to three inclination angles in the storage unit 23 in advance. That is, it is only necessary to store in advance the pressure dependences of capacitance with respect to two combinations of angles like A and B or B and C described above. This capacitance diaphragm gauge corrects a pressure measurement value based on the pressure dependences of capacitance with respect to these two inclination angles.

As described above, the capacitance diaphragm gauge of the present invention can correct a pressure measurement value in accordance with the inclination angle of the gauge regardless of the inclination angle. Even in a case in which the capacitance diaphragm gauge cannot be installed with the connection fitting facing the downward direction, therefore, there is no need to adjust the gauge in any special manner. It is therefore possible to manufacture a capacitance diaphragm gauge at a low cost.

While the present invention has been described with reference to exemplary embodiments, it is to be understood that the invention is not limited to the disclosed exemplary embodiments. The scope of the following claims is to be accorded the broadcast interpretation so as to encompass all such modifications and equivalent structures and functions.

This application claims the benefit of Japanese Patent Application No. 2008-327966 filed Dec. 24, 2008, Japanese Patent Application No. 2009-282207 filed Dec. 11, 2009, which are hereby incorporated by reference herein in their entirety.

What is claimed is:

1. A capacitance diaphragm gauge comprising:
a vacuum sealed chamber including a diaphragm electrode;
a fixed electrode provided inside said vacuum sealed chamber so as to face the diaphragm electrode; and
an inclination angle sensor configured to detect an inclination angle of the capacitance diaphragm gauge.

2. The gauge according to claim 1, further comprising:
a capacitance detection unit configured to detect a capacitance between the diaphragm electrode and said fixed electrode;
a storage unit configured to store a pressure dependence of capacitance between the diaphragm electrode and said fixed electrode on a predetermined inclination angle; and
a pressure correction unit configured to correct a pressure at an inclination angle associated with the inclination angle information, based on the inclination angle information detected by said inclination angle sensor and the pressure dependence of capacitance stored in said storage unit.

3. The gauge according to claim 2, wherein the predetermined inclination angle includes a first inclination angle corresponding to a horizontal direction, a second inclination angle corresponding to a vertically upward direction, and a third inclination angle corresponding to a vertically downward direction.

4. The gauge according to claim 2, wherein said storage unit stores the pressure dependence of capacitance at the predetermined inclination angle in a pressure range wider than an operating pressure range of the capacitance diaphragm gauge.

5. The gauge according to claim 2, wherein
the predetermined inclination angle includes a first inclination angle corresponding to a horizontal direction and a second inclination angle which differs from the first inclination angle by 90°, and
said pressure correction unit corrects the pressure at an inclination angle associated with the inclination angle information between the first inclination angle and the second inclination angle, based on the pressure dependences at the two inclination angles.

6. A vacuum apparatus comprising a capacitance diaphragm gauge defined in claim 1.
